(19) United States
(12) Patent Application Publication
(10) Pub. No.: US 2013/0167542 A1
(43) Pub. Date: Jul. 4, 2013

(54) FLOWSLEEVE OF A TURBOMACHINE COMPONENT

(71) Applicants: Lucas John Stoia, Taylors, SC (US); Russell Pierson DeForest, Simpsonville, SC (US); Patrick Benedict Melton, Horse Shoe, NC (US)

(72) Inventors: Lucas John Stoia, Taylors, SC (US); Russell Pierson DeForest, Simpsonville, SC (US); Patrick Benedict Melton, Horse Shoe, NC (US)

(73) Assignee: GENERAL ELECTRIC COMPANY, Schenectady, NY (US)

(21) Appl. No.: 13/343,200

(22) Filed: Jan. 4, 2012

(51) Int. Cl. F02C 7/22

(52) U.S. Cl. 60/738

(57) ABSTRACT

A flowsleeve of a turbomachine component is provided. The flowsleeve includes an annular body including an upstream casing and a downstream casing. The upstream casing defines a fuel feed, and the downstream casing defines an airway opening, and a premixing passage. The premixing passage is fluidly coupled to the fuel feed and the airway opening and has a passage interior in which fuel and air receivable from the fuel feed and the airway opening, respectively, are combinable to form a fuel and air mixture.

### BACKGROUND OF THE INVENTION

The subject matter disclosed herein relates to a flowsleeve of a turbomachine component.

A turbomachine, such as a gas turbine engine, may include a compressor, a combustor and a turbine. The compressor compresses inlet air and the combustor combusts the compressed inlet air along with fuel to produce a fluid flow of high temperature fluids. Those high temperature fluids are directed to the turbine where the energy of the high temperature fluids is converted into mechanical energy that can be used to generate power and/or electricity. The turbine is formed to define an annular pathway through which the high temperature fluids pass.

Often, the combustion occurring within the combustor produces pollutants and other undesirable products, such as oxides of nitrogen (NOx), which are exhausted into the atmosphere from the turbine. Recently, however, efforts have been undertaken to reduce the production of such pollutants. These efforts have included the introduction of axially staging fuel injection within the combustor and/or other types of late lean injection (LLI) systems.

### BRIEF DESCRIPTION OF THE INVENTION

According to one aspect of the invention, a flowsleeve of a turbomachine component is provided. The flowsleeve includes an annular body including an upstream casing and a downstream casing. The upstream casing defines a fuel feed, and the downstream casing defines an airway opening, and a premixing passage. The premixing passage is fluidly coupled to the fuel feed and the airway opening and has a passage interior in which fuel and air receivable from the fuel feed and the airway opening, respectively, are combinable to form a fuel and air mixture.

According to another aspect of the invention, a turbomachine component is provided and includes a first vessel having an upstream end defining a first interior in which combustion occurs and a downstream end defining a second interior through which products of the combustion flow, a second vessel configured to be disposed about the downstream end of the first vessel, the second vessel defining a fuel feed, an airway opening and a premixing passage fluidly coupled to the fuel feed and the airway opening and having a passage interior in which fuel and air receivable from the fuel feed and the airway opening, respectively, are combinable to form a fuel and air mixture and an injector coupled to the premixing passage and configured to transport the fuel and air mixture to the second interior.

According to yet another aspect of the invention, a turbomachine component is provided and includes a first vessel having an upstream end defining a first interior in which combustion occurs and a downstream end defining a second interior through which products of the combustion flow, a second vessel configured to be disposed about the downstream end of the first vessel, the second vessel defining at multiple circumferential locations a fuel feed, an airway opening, a premixing passage fluidly coupled to the fuel feed and the airway opening and having a passage interior in which fuel and air receivable from the fuel feed and the airway opening, respectively, are combinable downstream from the airway opening to form a fuel and air mixture, and a plenum at a downstream end of the premixing passage and multiple injectors, each of the multiple injectors being coupled to the plenum and configured to transport the fuel and air mixture to the second interior.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side view of a turbomachine component; and

FIG. 2 is a radial view of the turbomachine component.

The detailed description explains embodiments of the invention, together with advantages and features, by way of example with reference to the drawings.

### DETAILED DESCRIPTION OF THE INVENTION

In accordance with aspects, a flowsleeve is provided for an axially staged or late lean injection (LLI) system that is coupled with micromixer injection technology to deliver partially or fully premixed fuel and air mixtures to a flowsleeve mounted injector. To this end, a combination of fuel and air passages are machined, drilled and/or cut into the flowsleeve walls such that an axial length of the flowsleeve draws compressor discharge (CDC) air inwardly from an exterior of the flowsleeve and through airway openings. This CDC air is then delivered to the injector along with fuel with which it has been mixed along the length of the flowsleeve. The configuration may ultimately result in overall reductions of emissions of oxides of nitrogen (NOx).

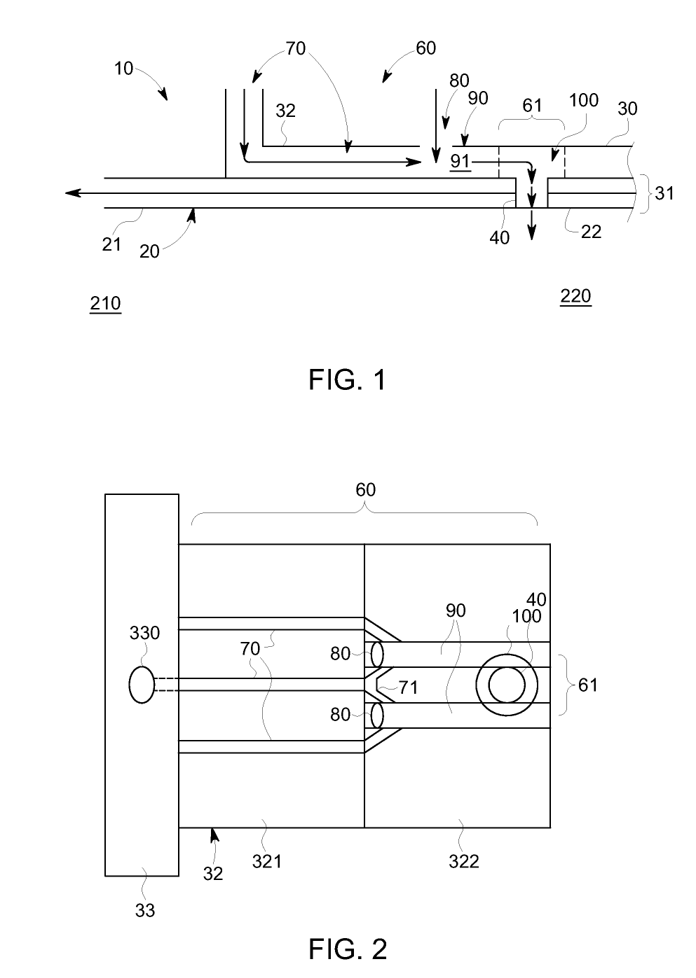

With reference to FIGS. 1 and 2, a turbomachine component 10 is provided as, for example, a downstream section of a combustor in a gas turbine engine. The turbomachine component 10 includes a first vessel 20, such as a combustor liner, a second vessel 30, such as a combustor flowsleeve and one or multiple injectors 40 that are mounted to the second vessel 30 in an axially staged or late lean injection (LLI) system.

The first vessel 20 has an upstream end 21 and a downstream end 22. The upstream end 21 is formed to define a first interior 210 therein in which combustion of combustible materials, such as a fuel and air, occurs. The downstream end 22 is formed to define a second interior 220 downstream from the first interior 210 through which products of the combustion flow as a main flow toward a transition piece and/or a turbine section. The second vessel 30 is configured to be disposed about at least the downstream end 220 of the first vessel 20 to define an annulus 31 between an outer surface of the first vessel 20 and an inner surface of the second vessel 30. The annulus 31 may be formed to define a flow path for fluid moving toward the upstream end 21 of the first vessel 20 from the transition piece 50 as impingement or cooling flow. Additional fluid/air may enter the annulus 31 in other manners as well.

The second vessel 30 defines one or multiple micromixing injection systems 60 at one or multiple circumferential locations 61 that may be arranged with uniform or non-uniform spacing. Each of the one or multiple micromixing injection systems 60 at each of the one or multiple circumferential locations 61 is defined to include at least one fuel feed 70, at least one airway opening 80, at least one premixing passage 90 and a least one plenum 100. For each micromixing injection system 60, the at least one premixing passage 90 is fluidly coupled to the at least one fuel feed 70 and the at least one airway opening 80 and has a passage interior 91 in which fuel and air, such as compressor discharge (CDC) air, which are respectively receivable from the at least one fuel feed 70 and the at least one airway opening 80, are combinable to form a fuel and air mixture. The at least one plenum 100 is defined at or near a downstream end of the at least one premixing passage 90.

The one or multiple injectors 40 are each disposed at corresponding one or multiple circumferential locations 61, respectively. With such a configuration, each multiple injector 40 may be coupled to a corresponding one of the plenums 100 and may be configured to extend radially inwardly from the second vessel 30 to traverse the annulus 31 and to transport the fuel and air mixture from the second vessel 30 toward the second interior 220 of the first vessel 20 such that the fuel and air mixture may be injected to and mixed with the main flow of the products of the combustion flowing toward the transition piece and/or the turbine section.

In accordance with embodiments, the second vessel 30 may include an annular body 32. The annular body 32 may include an upstream casing 321 and a downstream casing 322, which may be welded or otherwise fastened together. The upstream casing 321 is formed to define one to three or more fuel feeds 70 at each of the one or multiple circumferential locations 61. The downstream casing 322 is similarly formed to define at each of the one or multiple circumferential locations 61 a pair of airway openings 80, a pair of premixing passages 90 and a plenum 100. The second vessel 30 may further include a manifold 33, which is disposed about the upstream casing 321 and formed to define a fuel inlet 330 and an interior into which a fuel supply may be provided.

As shown in FIG. 2, the pair of premixing passages 90 may be disposed circumferentially adjacent to one another with a circumferential distance between them that is similar to a diameter of the corresponding one of the multiple injectors 40. Each of the pair of the premixing passages 90 extends substantially in parallel and in an axially downstream direction along a length of the downstream casing 322. Each of the pair of the airway openings 80 is defined at or near an upstream end of a corresponding one of the premixing passages 90 and has, for example, an elongate shape with a length that is substantially similar to a width of the associated premixing passage 90. A main one of the fuel feeds 70 may be disposed to extend from the manifold 33 in an axially downstream direction along a length of the upstream casing 321 at a circumferential location that is generally between the premixing passages 90. Fluid couplings 71 extend transversely from a downstream end of the fuel feed 70 to the premixing passages 90 downstream from the airway openings 80. Additional fuel feeds 70 may be disposed proximate to the main one of the fuel feeds 70 along with additional fluid couplings 71. In this way, at least one to three fuel feed(s) 70 may be provided for each one of the multiple injectors 40.

In an operation of the turbomachine component 10, fuel may be fed to the fuel feeds 70 by way of the fuel inlet 330 of the manifold 33. The fuel is then transported axially downstream by the fuel feeds 70 to the premixing passages 90. Within the premixing passages 90, the fuel is mixed with CDC air entering the premixing passages 90 by way of the airway openings 80. The resulting fuel and air mixture is then transported axially downstream along the premixing passages 90 to the plenums 100 at which the fuel and air mixture is communicated into the multiple injectors 40. The multiple injectors 40 then inject the fuel and air mixture into the second interior 220 and the main flow of the products of the combustion.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A flowsleeve of a turbomachine component, the flowsleeve comprising:
an annular body including an upstream casing and a downstream casing,
the upstream casing defining a fuel feed, and
the downstream casing defining an airway opening, and a premixing passage,
the premixing passage being fluidly coupled to the fuel feed and the airway opening and having a passage interior in which fuel and air receivable from the fuel feed and the airway opening, respectively, are combinable to form a fuel and air mixture.

2. The flowsleeve according to claim 1, wherein the upstream casing and the downstream casing correspondingly define the fuel feed, the airway opening and the premixing passage, respectively, at multiple circumferential locations.

3. The flowsleeve according to claim 2, wherein the fuel feed is defined at each of the multiple circumferential locations as one to three fuel feeds.

4. The flowsleeve according to claim 2, wherein the airway opening and the premixing passage are respectively defined at each of the multiple circumferential locations as respective pairs thereof.

5. The flowsleeve according to claim 1, wherein the air provided from the airway opening comprises compressor discharge air.

6. The flowsleeve according to claim 1, wherein the downstream casing defines the airway opening with an elongate shape, a width of the premixing passage being substantially similar to a length of the airway opening.

7. The flowsleeve according to claim 1, wherein the downstream casing further defines a plenum at a downstream end of the premixing passage.

8. The flowsleeve according to claim 1, further comprising a manifold disposed about the upstream casing to define a fuel inlet coupled to the fuel feed.

9. The flowsleeve according to claim 1, wherein the downstream casing is welded to the upstream casing.

10. A turbomachine component, comprising:
a first vessel having an upstream end defining a first interior in which combustion occurs and a downstream end defining a second interior through which products of combustion flow;
a second vessel configured to be disposed about the downstream end of the first vessel,
the second vessel defining a fuel feed, an airway opening and a premixing passage fluidly coupled to the fuel feed and the airway opening and having a passage interior in which fuel and air receivable from the fuel feed and the airway opening, respectively, are combinable to form a fuel and air mixture; and
an injector coupled to the premixing passage and configured to transport the fuel and air mixture to the second interior.

11. The turbomachine component according to claim 10, wherein the first vessel and the second vessel define an annulus therebetween, which is traversed by the injector.

12. The turbomachine component according to claim 10, wherein the injector is plural in number, the plural injectors being arrayed about the second interior.

13. The turbomachine component according to claim 10, wherein the premixing passage is defined as a pair of premixing passages.

14. The turbomachine component according to claim 10, wherein the fuel feed is defined as one to three fuel feeds.

15. The turbomachine component according to claim 10, wherein the air provided from the airway opening comprises compressor discharge air.

16. The turbomachine component according to claim 10, wherein the airway opening is defined with an elongate shape, a width of the premixing passage being substantially similar to a length of the airway opening.

17. The turbomachine component according to claim 10, wherein the second vessel is formed to define a plenum at a downstream end of the premixing passage, the injector being fluidly coupled to the plenum.

18. The turbomachine component according to claim 10, wherein the second vessel comprises:
a downstream casing in which the airway opening and the premixing passage are defined;
an upstream casing in which the fuel feed is defined; and
a manifold disposed about the upstream casing to define a fuel inlet coupled to the fuel feed.

19. The turbomachine component according to claim 18, wherein the downstream casing is welded to the upstream casing.

20. A turbomachine component, comprising:
a first vessel having an upstream end defining a first interior in which combustion occurs and a downstream end defining a second interior through which products of combustion flow;
a second vessel configured to be disposed about the downstream end of the first vessel,
the second vessel defining at multiple circumferential locations:
a fuel feed,
an airway opening,
a premixing passage fluidly coupled to the fuel feed and the airway opening and having a passage interior in which fuel and air receivable from the fuel feed and the airway opening, respectively, are combinable downstream from the airway opening to form a fuel and air mixture, and
a plenum at a downstream end of the premixing passage; and
multiple injectors, each of the multiple injectors being coupled to the plenum and configured to transport the fuel and air mixture to the second interior.
